(19) United States
(12) Patent Application Publication
(10) Pub. No.: US 2025/0319432 A1
(43) Pub. Date: Oct. 16, 2025

(54) SEPARATOR

(71) Applicant: Edwards Limited, Burgess Hill, Sussex (GB)

(72) Inventors: Gary Peter Knight, Burgess Hill, Sussex (GB); Mark Richard O'Neill, Clevedon, Somerset (GB)

(21) Appl. No.: 18/866,248

(22) PCT Filed: May 16, 2023
(86) PCT No.: PCT/GB2023/051285

§ 371 Date: Nov. 15, 2024

(30) Foreign Application Priority Data
May 17, 2022 (GB) 2207180.7

(51) Int. Cl. B01D 50/40; B01D 45/16; B01D 47/06; B01D 47/10; B04C 3/00; B04C 3/06; B04C 9/00

(52) U.S. Cl. CPC B01D 50/40; B01D 45/16; B01D 47/06; B01D 47/10; B04C 3/06; B04C 9/00; B04C 2003/006; B04C 2009/008

(57) ABSTRACT

A separator for separating contaminants suspended within an effluent stream includes an inlet conduit configured to receive from an effluent stream containing contaminants flowing in a first major direction from a lower portion of said separator towards an upper portion of said separator; a spray nozzle configured to spray an entraining fluid within the inlet conduit in the first major direction to entrain the contaminants within the effluent stream; a first flow redirection structure located downstream of the inlet conduit; and a first separation conduit located downstream of the first flow redirection structure, wherein the first flow redirection structure is configured to redirect flow of the effluent stream and the entraining fluid from an axial flow from the inlet conduit to a circumferential flow in a second major direction opposing the first major direction within the first separation conduit.

### CROSS-REFERENCE OF RELATED APPLICATION

This application is a Section 371 National Stage Application of International Application No. PCT/GB2023/051285, filed May 16, 2023, and published as WO 2023/223018 A1 on Nov. 23, 2023, the content of which is hereby incorporated by reference in its entirety and which claims priority of British Application No. 2207180.7, filed May 17, 2022.

### FIELD

The field of the invention relates to separators.

### BACKGROUND

Separators are known. Separators can be used to separate contaminants suspended within a fluid stream. Although such separators exist, they can have shortcomings. Accordingly, it is desired to provide an improved separator.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided a separator for separating contaminants suspended within an effluent stream, comprising: an inlet conduit configured to receive from an abatement apparatus the effluent stream containing contaminants flowing in a first major direction from a lower portion of said separator towards an upper portion of said separator; a spray nozzle configured to spray an entraining fluid within the inlet conduit in the first major direction to entrain the contaminants within the effluent stream; a first flow redirection structure located downstream of the inlet conduit; and a first separation conduit located downstream of the first flow redirection structure, wherein the first flow redirection structure is configured to redirect flow of the effluent stream and the entraining fluid from an axial flow from the inlet conduit to a circumferential flow in a second major direction opposing the first major direction within the first separation conduit.

The first aspect recognises that venturi scrubbers typically comprise a venturi tube, which itself comprises an initial converging section, sometimes a parallel sided throat section, followed by a diverging section, coupled to some method of introducing a liquid phase flow. The liquid phase flow input can be located either upstream, or within the throat, and can include a spray nozzle, a showerhead, or an overflowing weir. Venturi scrubbers have long been used as a method to turbulently mix multiple phases (gas-liquid, gas-particle-liquid) with the purpose of transferring materials from one phase to another. For gas-liquid mixtures, this is most often to facilitate the transfer of a water-soluble gas, generally a minor component of a gas mixture, to the liquid phase. The liquid phase is frequently water, although other liquids and solutions are used such as solutions of an alkaline compound, e.g., lime (CaO), for enhanced acid scrubbing or desulphurisation processes. For gas-particle-liquid operation, the purpose is generally to transfer particles, which could be solid dust particles (dedusting) or liquid droplets (mist elimination), from the gas phase to the liquid phase. Venturi Scrubbers can be classified into one of two configurations depending upon how the fluid motive force is applied to the system. The first configuration, generally referred to simply as a venturi scrubber, uses a venturi tube into which the liquid is introduced under low to moderate pressure. As the multiphase mixture passes through the venturi tube it experiences turbulent mixing. Although the fluid static pressure inside the venturi throat falls as the fluid velocity increases (Bernoulli's principle) there is an overall pressure drop from inlet to outlet of the venturi tube. The degree of turbulence, and therefore the efficiency of interphase mixing and material transfer, is dependent upon the velocity of the gas flowing through the venturi. High efficiency is only obtained by high velocity and therefore high pressure drop. Thus, the fluid motive force must be applied to the gas phase via a gas pumping mechanism such as a fan or blower. The second configuration, generally referred to as a venturi-ejector scrubber, uses a high pressure/high velocity jet or spray of the liquid phase flow to provide motive force to the combined fluid flow and the turbulent mixing of the phases. A useful side effect of this is that the gas phase is effectively pumped through the Venturi so there is no need to use a fan or blower. This is particularly advantageous when the gas phase is hot or chemically very reactive. The venturi-ejector configuration was chosen for development by the inventors, as part of an abatement system, as they realised it was able to solve three problems simultaneously: powder emissions, water-soluble gas scrubbing and system pressure drop. An integral part of any configuration of a venturi scrubber system is the need to separate the post-venturi multiphase mixture so that the liquid phase (sometimes referred to herein as entrainment fluid, scrubber liquid or scrubber liquor) can be either disposed of or recycled. Traditionally, both configurations described above are configured with the fluid flowing with gravity. The exhaust of the scrubber discharges into a gas-liquid separator. This gas-liquid separator is generally in the form of a tank which permits gravitational settling of large liquid droplets. Generally, the tank gas-phase exhaust stream contains smaller liquid droplets of mist and this then passes through a final stage such as a cyclone-separator or swirl-separator tower. This design results in a substantial footprint and cost associated with the additional downstream separators. For integration into an abatement system, where footprint is at a premium, a compact design of gas-liquid separator and venturi-ejector scrubber was envisaged. Initial designs of the separator section focused on implementing in parallel, multiple, cyclone separators. However, the high liquid/gas ratios (>1 litres liquid/m3 gas) employed by the venturi-ejector scrubber overwhelmed the cyclones resulting in unstable flow with an unacceptable pressure drop and excessive liquid (droplet) carryover.

Accordingly, a separator for separating contaminants or particulates typically suspended within a flue gas stream or an effluent stream is provided. The separator may comprise an inlet conduit configured to receive from an abatement apparatus the effluent stream containing contaminants flowing in a first major direction. The separator may comprise a spray nozzle configured to spray an entraining fluid within the inlet conduit in the first major direction to entrain or capture the contaminants within the effluent stream. The first major direction may be from a lower portion of said separator towards an upper portion of said separator. The separator may comprise a first flow redirection structure located or positioned downstream of the inlet conduit. The separator may comprise a first separation conduit located or positioned downstream of the first flow redirection structure. The first flow redirection structure may be configured to redirect flow of the effluent stream and the entraining fluid to a second major direction opposing the first major direction within the first separation conduit. The first flow redirection structure may redirect flow of the effluent stream and the entraining fluid from an axial flow to a circumferential flow. The circumferential flow may convey the effluent stream and the entraining fluid with a circumferential component in the second major direction. In this way, separation of the contaminants entrained by the entraining fluid from the effluent stream is encouraged since the change in the direction of flow helps to create a longer flow path while keeping the footprint and dimensions of the separator to a minimum. Also, this can provide a separator that exhausts effluent containing less entraining fluid than conventional venturi-ejector scrubbers. This can obviate the need for additional downstream apparatus such as cyclone separators which add to the cost and size of the apparatus.

Contaminants of the effluent stream can include suspended particulates or powders and unwanted gases which may be acidic. A major direction is typically a direction of the primary, net or overall fluid flow. A separation conduit is typically a conduit in which separation of the entraining fluid from the effluent stream can occur. Other processes may also occur in the separation conduits. The entraining fluid to be separated from the effluent gas may be water.

The inlet conduit may enlarge in the first major direction towards the first flow redirection structure. The inlet conduit may comprise a narrowing portion, an enlarging portion and a neck portion in between-a venturi tube. The inlet conduit may have an inlet at a base or lower part of the separator which receives the effluent stream and an outlet at a top or upper part of the separator. The first major direction may be from a base or lower part of the separator to a top or upper part of the separator.

The first flow redirection structure may be located between the inlet conduit and the first separation conduit.

The first flow redirection structure may be configured to redirect an axial flow from the inlet conduit to a circumferential flow in the first separation conduit.

The separator may comprise a second flow redirection structure located downstream of the first separation conduit and a second separation conduit located downstream of the second flow redirection structure. The second flow redirection structure may be configured to redirect flow of the effluent stream and the entraining fluid to the first major direction opposing the second major direction within the second separation conduit. Hence, a further change in major flow direction can be created which helps to further lengthen the flow path while keeping the footprint and dimensions of the separator to a minimum. The second flow redirection structure and second separation conduit provide additional length to the flow path allowing further separation to occur. The conditions in the first separation conduit and the second separation conduit may be different to improve overall separation. For example, the effluent stream may go from a high speed to a slow speed and/or a rotational flow to a linear flow.

The second flow redirection structure may be located between the first separation conduit and the second separation conduit.

The second flow redirection structure may be configured to redirect a circumferential flow from the first separation conduit to an axial flow in the second separation conduit.

The first separation conduit and/or the second separation conduit may coaxially surround the inlet conduit.

The first separation conduit and the second separation conduit may comprise nested annular tubes that coaxially surround the inlet conduit. The second separation conduit may be located radially between the first separation conduit and the inlet conduit. The first separation conduit may be located radially between the second separation conduit and the inlet conduit. These coaxial formations can provide for a compact separator. The first separation tube may be formed between or defined by an outer annular housing and an intermediate annular housing and the second separation conduit may be defined by the intermediate annular housing and an inner annular housing structure. This provides for a nested structure where one conduit feeds another coaxially-located conduit with the flow paths alternating in direction through each conduit.

At least one of the first flow redirection structure and the second flow redirection structure may be configured to present a curved or contoured surface to the effluent stream and the entraining fluid to redirect flow of the effluent stream and the entraining fluid. The curved surface can facilitate the redirection of the effluent-entraining fluid mix and may in some arrangements may provide an element of rotational flow. The rotational flow may be a circumferential flow around the first separation conduit. The curved surface of the first flow redirection structure may be provided by a curved cone structure. This can provide an even distribution of the effluent-entraining fluid mix to the first separation conduit which can improve separation efficiency.

The first flow redirection structure may comprise first radial elements or lobes extending between the inlet conduit and the first separation conduit.

The first radial elements may be positioned circumferentially around the inlet conduit. The first radial elements can act in addition to the cone to guide the flow through the redirection structure.

The inlet conduit may define a longitudinal axis. The first radial elements may be configured to impart a rotational or circumferential flow about the longitudinal axis to the effluent stream and the entraining fluid within the first separation conduit. By inducing a rotational or circumferential flow, a helix-shaped or spiral-shaped fluid flow path may be created in the first separation conduit in the second major direction. The rotational flow can greatly increase the path length of the effluent stream, thereby providing greater opportunity for separation. Moreover, a centrifugal effect can be created which pushes the heavier entraining liquid to the radial exterior of the first separation conduit, thereby separating it from the lighter effluent gas. This is a similar effect realised in a cyclone separator-however, advantageously, no moving/spinning element is required to induce the centrifugal force in the present arrangement.

The rotational flow may comprise a circumferential flow around the first separation conduit.

The first radial elements may be shaped to present a curved surface to the effluent stream and the entraining fluid to impart the rotational flow. In other words, the first radial elements may present a non-linear surface which changes direction from generally radial to generally circumferential to impart the rotation or circumferential flow.

The first radial elements may comprise a claw-shaped or curved teardrop cross-section.

Adjacent first radial elements may at least partially define curved channels to impart the rotational flow.

The first radial elements may define an exhaust conduit fluidly coupled to the second separation conduit and configured to convey the effluent stream from the second separation conduit to an exhaust. The exhaust can lead to downstream apparatus, for example, a packet bed scrubber. The exhaust conduit may be orientated to convey the effluent stream to the exhaust in the first major direction. The exhaust conduit may be positioned at an upper portion of the separator.

The second flow redirection structure may comprise second radial elements extending between the first separation conduit and the second separation conduit.

The second radial elements may be positioned circumferentially around the first separation conduit and the second separation conduit.

The second radial elements are configured to inhibit or restrict rotational flow of the effluent stream and the entraining fluid within the first separation conduit and the second separation conduit.

The second radial elements may be shaped to present a planar surface to the effluent stream and the entraining fluid to inhibit the rotational flow. In other words, the second radial elements may present a linear surface impart a linear flow.

Adjacent second radial elements may at least partially define radial channels to inhibit the rotational flow.

The second radial elements may comprise flat plates or baffles. The second radial elements can slow the flow of entraining fluid and effluent which can facilitate separation. Moreover, the second radial elements can inhibit the rotational flow induced upstream by the first redirection structure. This allows for a slow, substantially laminar and/or linear flow through the second separation conduit such that the exhaust of the separator is less turbulent.

The second flow redirection structure may define at least one outlet, drain or exhaust hole positioned or configured to drain accumulated entraining fluid into a sump.

The separator may comprise at least one other drainage channel, exhaust conduit or outlet configured to drain liquid accumulated downstream of the exhaust and exhaust conduit of the separator into the sump, the at least one drainage channel being configured to maintain a separation between the liquid being drained and the entraining fluid and the effluent stream within the inlet conduit, first flow redirection structure, first separation conduit, second flow redirection structure, second separation conduit and exhaust conduit such that re-entrainment is prevented. The drainage channel can provide a drainage route to the sump for any entrainment fluid or liquid contaminants remaining in the effluent stream after being passed through the separator and prior to entering any downstream apparatus. This enables liquid from the exhaust conduit in the upper portion of the separator to be conveyed to the sump in the lower portion of the separator.

The at least one drainage channel may extend through the first flow redirection structure, the first radial elements and the second separator conduit. This arrangement provides an exhaust channel that does not add to the footprint or height of the separator.

The second separation conduit may be dimensioned such that an average velocity within the second separator conduit is less than 6 m/s, preferably less than 3 m/s. Low speeds such as these can facilitate separation of entrainment fluid and contaminants from the effluent stream. Whilst the second radial elements of the second flow redirection structure can help achieve this flow rate, the size of the second separation conduit can determine the flow speed therethrough. A larger conduit may provide a slower flow whereas a smaller conduit may provide a faster flow. It should be noted that the dimensions throughout the separator should be selected such there is sufficient pressure in the exhaust conduit to exhaust the effluent stream.

The first major direction may be substantially vertically upwards (against gravity) and the second major direction is substantially vertically downwards (with gravity). As mentioned above, conventional venturi-ejector scrubbers spray entrainment fluid in a downwards direction. The inventors realised that by doing the opposite an obscure path which changes direction can be created without detrimental effect to the venturi-ejector scrubber.

In embodiments, the entraining fluid is one of: water, an alkaline solution and an acid solution. An alkaline compound, e.g., lime (CaO), may provide enhanced acid scrubbing or desulphurisation processes. An acid solution may enhance capture of alkaline gases such as ammonia.

A second aspect provides a method for separating contaminants from an effluent stream using a separator comprising: receiving the effluent stream at an inlet conduit of the separator in a first major direction; spraying an entraining fluid within the inlet conduit in the first major direction to entrain the contaminants; redirecting the flow of entraining fluid and effluent stream to a second major direction opposing the first major direction using a first flow redirection structure positioned downstream of the inlet conduit; and separating the entraining fluid containing contaminants from the effluent stream using a first separation conduit.

The method may comprise steps corresponding to the steps performed by the features of the first aspect set out above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 shows a section through a separator according one embodiment;

FIG. 2 shows a section of the separator of FIG. 1 with parts removed for clarity;

FIG. 3 shows the section of the separator shown in FIG. 2 with the outer housing removed for clarity;

FIG. 4 shows a section of a top portion of the separator of FIG. 1;

FIG. 5 shows the top portion shown in FIG. 4 from another angle;

FIG. 6 shows a phantom line drawing of another top portion of the separator of FIG. 1; and

FIG. 7 shows a section of the separator of FIG. 1 connected to a packed bed.

### DETAILED DESCRIPTION

Before discussing the embodiments in any more detail, first an overview will be provided. Some embodiments provide a separator for separating contaminants such as particulates within a flue gas stream or a treated effluent stream using an entraining fluid. The separator is configured to redirect flow of the treated effluent stream and the entraining fluid travelling in a first major direction to a second major direction which is opposite the first major direction. This elongates the length of flow within the separator which increases the dwell time and increases the likelihood of the entraining fluid capturing and separating contaminants while keeping the separator compact. The separator may further redirect the flow of said treated effluent stream and said entraining fluid (effluent-entraining fluid mix) back towards said first major direction opposing said second major direction within said second separation conduit. This further elongates the length of flow within the separator which increases the dwell time and increases the likelihood of the entraining fluid capturing and separating contaminants while keeping the separator compact.

Existing venturi-ejector scrubbers spray entraining fluid in a downwards direction. The entraining fluid is collected into a sump at a base of the scrubber and the effluent gas is allowed to exit through an outlet above the sump. However, such an arrangement can have a large footprint. Furthermore, entraining fluid droplets are often carried through the outlet by the effluent stream leading to additional apparatus being required downstream of the scrubber such as cyclone separators which further increase size, cost and complexity. In contrast, in some embodiments, the first major direction may be an upwards direction and the second major direction may be a downwards direction.

Hence, some embodiments aim to provide a novel venturi-ejector scrubber combined with a gas (e.g., effluent)-liquid (e.g., entraining fluid) separator which overcomes at least one of the above-described problems. Primarily, some embodiments facilitate improved separation whilst minimising the dimensions of the separator by redirecting the effluent-entraining fluid mixture one or more times. Separation may be further improved if the first redirection provides a rotational flow which creates a type of centrifugal separator. Separation may also be improved if the path length is increased. Separation of droplets may further be induced by a low speed section, for example, less than 6 m/s, preferably less than 3 m/s. Some embodiments aim to provide these different conditions conducive to separation. In some cases, different contaminants may be prone to separation in different conditions. The first and second flow redirection structures and first and second separation conduits may be shaped and dimensioned appropriately to provide the conditions conducive to separation.

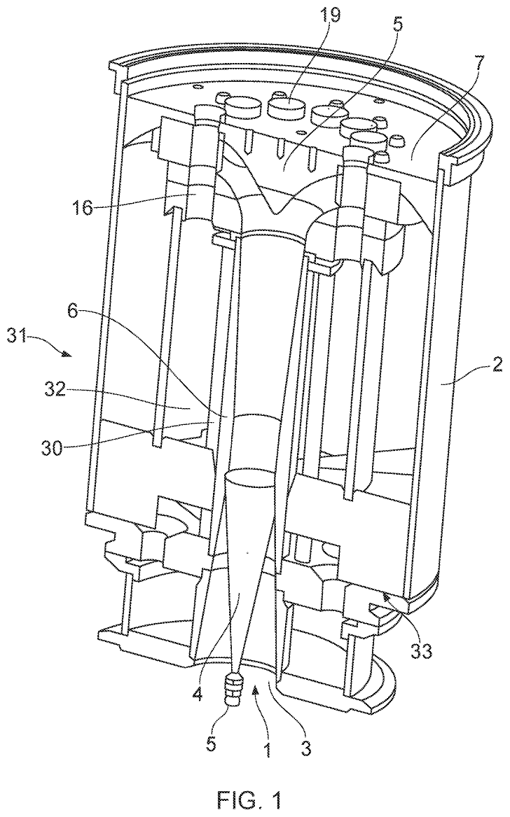

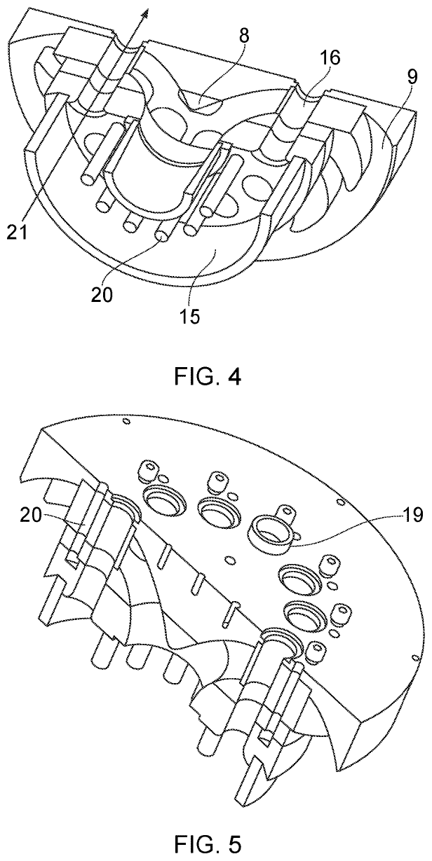

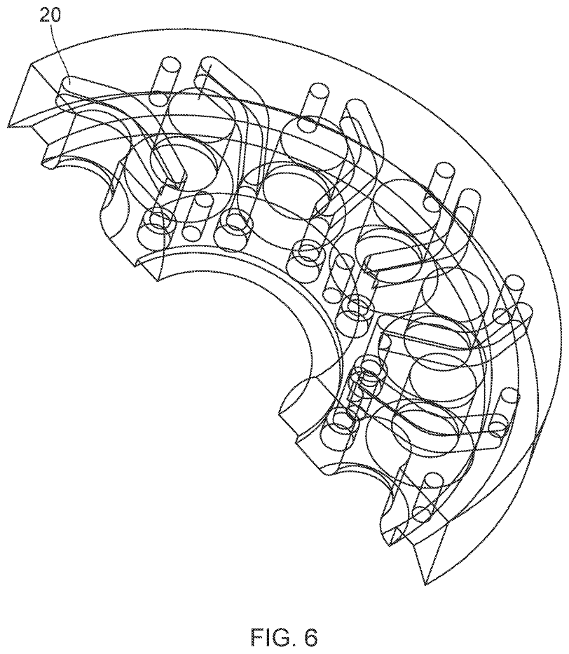

FIGS. 1 to 6 show an embodiment of a separator 2, also referred to herein as a combined venturi-ejector scrubber and gas-liquid separator, comprising an inlet 3, an inlet conduit 6, a first flow redirection structure 7, a first separation conduit 31, a second flow redirection structure 33, a second separation conduit 32 and an exhaust conduit 16.

The inlet 3 positioned at a lower portion of the separator 2 is configured to receive an effluent stream 1 containing contaminants such as particulates. The inlet 3 leads to an inlet conduit 6, also referred to herein as a venturi tube, which is defined by an inner tube or housing 30. The inlet conduit 6 defines a longitudinal axis. A first major direction is defined by the effluent flow in the inlet conduit 6 along its longitudinal axis in a generally upwards direction. The inlet conduit 6 may be formed of two tapered portions—an initial narrowing portion followed by an enlarging portion—to create the venturi tube.

A high velocity spray 4 is released in a neck of the inlet conduit 6 defined between the two tapered portions. A hydraulic atomising spray nozzle 5 associated with the spray 4 is configured to spray an entraining fluid within the inlet conduit 6 along the first major direction to entrain the contaminants within the effluent stream 1. The entraining fluid can be a high pressure hydraulically atomised water spray.

Downstream of the inlet conduit 6, a first flow reversing structure or flow redirection structure 7 is configured to redirect the effluent-entraining fluid mixture, sometimes referred to as effluent stream, towards a second major direction different to the first major direction. The second major direction can be directly opposite to the first major direction and parallel to the longitudinal axis. The first flow redirection structure 7 comprises an axially mounted cone shaped portion, or cone 8, and a plurality of first radial elements 9, sometimes referred to as flow redirecting elements. The cone 8 is mounted pointed side down and presents a curved surface towards the effluent-entraining fluid mixture. The cone 8 may comprise a vortex-like shape.

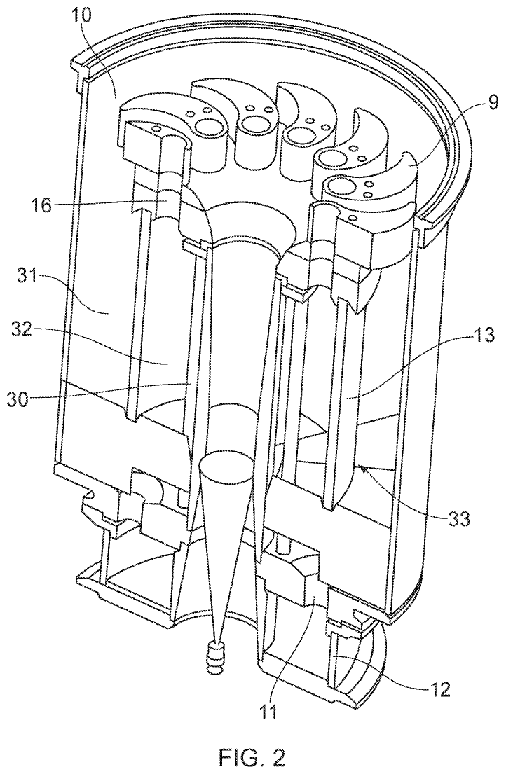

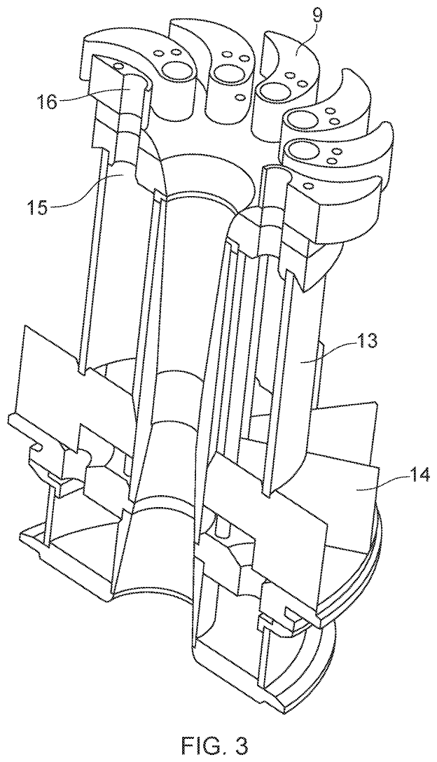

FIGS. 2 and 3 show the first radial elements 9 are positioned circumferentially around the longitudinal axis and comprise claw-shaped elements with curved surfaces. Adjacent first radial elements 9 define channels through which the effluent-entraining fluid mixture is directed. It is preferred that the channels are curved, however, it will be appreciated that other shapes, not necessarily curved shapes, are suitable for the first radial elements 9 to guide the effluent-entraining fluid mixture.

The cone 8 and the first radial elements 9 are configured to redirect the effluent-entraining fluid mixture into a first separation conduit 31 defined between an outer tube or housing 10 and an intermediate tube or housing 13, sometimes referred to herein as an inner flow guide. The first separation conduit 31 is coaxial with the inlet conduit 6 and is positioned about the inlet conduit 6 such that the first separation conduit 31 comprises an annular passage.

The curved surfaces of the cone 8 and the first radial elements 9 of the first flow redirection structure 7 are configured to impart a rotational or circumferential flow to the effluent-entraining fluid mixture such that the effluent passes through the first separation conduit 31 in a helical or spiral flow path.

The separator 2 further comprises a second flow redirection structure 33 positioned downstream of the first separation conduit 31. The second flow redirection structure 33 is configured to redirect flow of the effluent-entraining fluid mixture back towards the first major direction from the second major direction. The second flow redirection structure 33 may further comprise second radial elements 14 configured to prevent rotational flow of the effluent-entraining fluid mixture thereby halting the rotational flow from the first separation conduit and restoring a linear flow. The second radial elements 14 comprise baffles or flat plates. The plates extend between an outer surface of the inner housing 30 and an inner surface of the outer housing 10.

The second flow redirection structure 33 may further comprise at least one drainage hole or outlet 11. The outlets 11 allow water to drain into a sump 12 positioned below the separator 2. The sump 12 may be integrally formed with the separator 2 or separately.

A second separation conduit 32 positioned downstream of the second flow redirection structure 33 is configured to provide a flow path for the effluent-entraining fluid mixture in the second major direction to an exhaust conduit 16.

The second separation conduit 32 is coaxial with and positioned radially between the inlet conduit 6 and the first separation conduit 31. It is defined between the inner housing 30 and the intermediate housing 13 such that the second separation conduit 32 comprises an annular passage. The first and second flow redirection structures 7, 33 are positioned at the axial ends of the nested coaxial tubes which form the inlet conduit 6, first separation conduit 31 and second separation conduit 32.

Downstream of the second separation conduit 32, the exhaust conduit 16 comprises a plurality of gas pipes positioned circumferentially around the downstream end of the second separation conduit 32. The gas pipes extend through the first flow redirection structure 7, in particular, through the first radial elements 9. The gas pipes fluidly interconnect the second separation conduit 32 to an exhaust at an upper portion of the separator 2. It will be appreciated that the exhaust conduit 16 may comprise a different number of gas pipes to that depicted in this embodiment. For example, the exhaust conduit 16 may comprise one or more gas pipes. The exhaust conduit 16 may comprise the same number of gas pipes as there are first radial elements 9 although this need not be the case.

Each gas pipe comprises an upstand 19 which extends above the first flow redirection structure 7 to prevent liquid accumulating on top of the separator 2 falling back through the exhaust and ‘re-entraining’. To drain the accumulated fluid without risking re-entrainment, the separator 2 comprises drainage or exhaust channels 20 also extending through the first flow redirection structure 7, in particular, the first radial elements 9. The drainage channels 20 are configured to allow scrubber water or other accumulated liquids to drain into the collection sump 12 without mixing with the effluent passing through the separator 2. The drainage channels 20 are positioned circumferentially radially outwards from the exhaust conduit 16 gas pipes and extend through the first flow redirection structure 7 towards the sump 12 below. It will be appreciated that the drainage channels 20 may comprise one or more drainage channels.

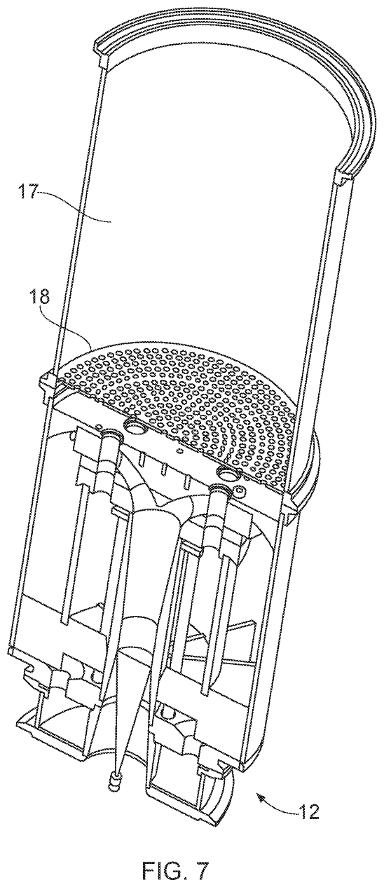

FIG. 7 shows an embodiment in which the separator 2 is followed by a packed bed wet scrubber 17 to augment the gas scrubbing performance. FIG. 7 shows the support plate 18 for the scrubber packing (scrubber packing not included for clarity). The features of this embodiment are short upstands 19 on the exit of the gas pipes 16 that allow the scrubber liquor to collect and then drain via channels 20 into the liquid collecting sump 12 without coming into significant contact with the gas stream 21. This prevents re-entrainment of liquid droplets back into the gas stream.

To maximise the efficiency of the packed bed scrubber it is helpful to ensure that the gas flow entering the bottom of the packed tower is as evenly distributed as possible. To that end, computational fluid dynamics (CFD) flow modelling of the flow exiting the gas-liquid separator permitted the optimisation of the hole size and distribution in the scrubber packing support plate 18. To optimise the support plate configuration, the size and density of the holes in direct line-of-sight of the gas-liquid separator exhaust ports/upstands 19 of the exhaust conduits should be reduced, forcing the gas flow to spread out.

In use, the gas-particle flow (effluent) stream 1 enters the separator 2 at its base and travels vertically upwards via the inlet 3 in the lower surface of the separator 2. Here it meets, and mixes with, the high velocity spray 4—shown as a cone in FIG. 1—supplied via the hydraulic atomising nozzle 5 as it passes through the Venturi inlet conduit 6. As it rises further, eventually leaving the Venturi inlet conduit 6, it enters the flow reversing portion of the apparatus. Note that in the following discussion, the sprayed entraining fluid may be referred to as water.

The effluent stream 1 is drawn into the separator 2 through a suction action provided by spraying water in the first major direction as well as being pressured by upstream effluent. In this way, the effluent containing contaminants is forced through the inlet conduit 6 and combined with the atomised water droplets. Acid gas particles and small powder in the effluent stream 1 are readily attached or absorbed into the atomised water because the droplets are typically of comparable size to the contaminants.

The use of a high-pressure spray allows the separator 2 to have a longer flow path. Having a low-pressure water spray would reduce the pressure or energy and would reduce the ability of the effluent to be redirected one or more times and still be exhausted from the separator without additional assistance from, for example, an external fan. A preferred speed of water through the inlet conduit 6 is between 50 and 150 m/s. At these speeds, it is immaterial that the spray is implemented in an upwards direction.

After leaving the Venturi inlet conduit 6, the effluent-entraining fluid mixture meets the axially mounted cone 8 which splits and directs the flow (radially) outwards towards flow-directing elements 9 which impart a combined tangential (rotational) and downward direction to the flow. As the effluent-entraining fluid mixture leaves the flow reversing portion 7 it is directed towards the inner surface of the outer housing 10. Upon hitting the inner surface of the outer housing 10, the momentum of the denser liquid-portion of the flow causes it to separate from the gas portion. The liquid forms a film on the inner surface of the outer housing 10 and falls, under gravity, towards the bottom of the separator 2.

The rotational/tangential/circumferential flow is preferable to a linear flow because it lengthens the distance travelled by the effluent-entraining fluid mixture, thereby allowing more time for separation to occur. Furthermore, the rotational motion can have a centrifugal effect which helps separate the contaminated water from the gas effluent. It should be noted that whilst the effluent-entraining fluid mixture follows a substantially helical path in the first separation conduit 31, the net flow is downwards (the second major direction).

Holes 11 in the bottom of the separator 2 allow the liquid to drain into the sump 12. The sump 12 collects the entraining fluid (scrubber liquid) which is then either recirculated through the system or pumped to a waste stream.

The remaining effluent-entraining fluid mixture, significantly reduced in the liquid portion but still carrying liquid droplets, continues to swirl around the outer annular chamber 31 of the gas-liquid separator. This flow continues to be directed downward, as well as tangentially/rotationally, by the presence of an inner flow guide 13 towards baffles 14. CFD simulation suggests that the peak velocity of the fluid, as it passes between the flow-directing elements, exceeds 15 ms−1 but by the time the fluid meets the baffles it is less than 6 ms−1 and slows further allowing remaining water droplets to settle under gravity and drain into the sump 12. The baffles help to change the circumferential flow to a more linear flow. The remaining flow, now largely free from liquid droplets, ascends the inner annular chamber 15 of the gas-liquid separator 2 and through an array of gas pipes 16. The dimensions of the inner annular chamber 15 are chosen such that the typical flow velocity is now less than 3 ms−1 and thus only able to carry the very smallest liquid droplets. Preferably, the effluent travels through the second separation conduit 32 at the lowest possible speed thereby providing maximum opportunity for the contaminants to be separated. Separated water can fall to the bottom of the second flow redirection structure where it drains into the sump 12 through the drainage holes 11.

In an alternative embodiment, the second separation conduit 32 may be positioned radially outwards of the first separation conduit 31 which in turn is positioned radially outwards of the inlet conduit 6. In this way a zig-zag type flow path may be formed. This arrangement may provide an alternative low-cost separator because the exhaust conduits and drainage channels may not need to pass through the first flow redirection structure.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A separator for separating contaminants within an effluent stream, comprising:
an inlet conduit configured to receive from an abatement apparatus said effluent stream containing contaminants flowing in a first major direction from a lower portion of said separator towards an upper portion of said separator;
a spray nozzle configured to spray an entraining fluid within said inlet conduit in said first major direction to entrain said contaminants within said effluent stream;
a first flow redirection structure located downstream of said inlet conduit; and
a first separation conduit located downstream of said first flow redirection structure, wherein said first flow redirection structure is configured to redirect flow of said effluent stream and said entraining fluid from an axial flow from the inlet conduit to a circumferential flow in a second major direction opposing said first major direction within said first separation conduit.

2. The separator of claim 1, wherein said inlet conduit enlarges in said first major direction towards said first flow redirection structure.

3. The separator of claim 1, wherein said first flow redirection structure is located between said inlet conduit and said first separation conduit.

4. The separator of claim 1, comprising a second flow redirection structure located downstream of said first separation conduit and a second separation conduit located downstream of said second flow redirection structure, wherein said second flow redirection structure is configured to redirect flow of said effluent stream and said entraining fluid to said first major direction opposing said second major direction within said second separation conduit.

5. The separator of claim 4, wherein said second flow redirection structure is located between said first separation conduit and said second separation conduit.

6. The separator of claim 4, wherein said first separation conduit and said second separation conduit coaxially surround said inlet conduit.

7. The separator of claim 1, wherein at least one of said first flow redirection structure and said second flow redirection structure is configured to present a curved surface to said effluent stream and said entraining fluid to redirect flow of said effluent stream and said entraining fluid.

8. The separator of claim 1, wherein said first flow redirection structure comprises first radial elements extending between said inlet conduit and said first separation conduit.

9. The separator of claim 8, wherein said first radial elements are positioned circumferentially around said inlet conduit.

10. The separator of claim 8, wherein said inlet conduit defines a longitudinal axis, and wherein said first radial elements are configured to impart a rotational flow about said longitudinal axis to said effluent stream and said entraining fluid within said first separation conduit.

11. The separator of claim 8, wherein said first radial elements are shaped to present a curved surface to said effluent stream and said entraining fluid to impart said rotational flow.

12. The separator of claim 4, wherein said first flow redirection structure comprises first radial elements extending between said inlet conduit and said first separation conduit and wherein said first radial elements define an exhaust conduit fluidly coupled to said second separation conduit and configured to convey said effluent stream from said second separation conduit to an exhaust.

13. The separator of claim 4, wherein said second flow redirection structure comprises second radial elements extending between said first separation conduit and said second separation conduit.

14. The separator of claim 13, wherein said second radial elements are positioned circumferentially around said first separation conduit and said second separation conduit.

15. The separator of claim 13, wherein said second radial elements are configured to inhibit rotational flow of said effluent stream and said entraining fluid within said first separation conduit and said second separation conduit.

16. The separator of claim 4, wherein said second flow redirection structure defines at least one outlet positioned to drain accumulated entraining fluid into a sump.

17. A method for separating contaminants from an effluent stream using a separator comprising:
receiving the effluent stream at an inlet conduit of the separator in a first major direction from a lower portion of said separator towards an upper portion of said separator;
spraying an entraining fluid within said inlet conduit in said first major direction to entrain said contaminants;
redirecting the flow of entraining fluid and effluent stream from an axial flow from the inlet conduit to a circumferential flow in a second major direction opposing the first major direction using a first flow redirection structure positioned downstream of the inlet conduit; and
separating the entraining fluid containing contaminants from the effluent stream using a first separation conduit.
